(19) United States
(12) Patent Application Publication
(10) Pub. No.: US 2024/0246183 A1
(43) Pub. Date: Jul. 25, 2024

(54) MODULAR MACHINE TOOL PROCESSING JIG

(71) Applicant: Will Excellence Smart Manufacturing CO., LTD., Taichung City (TW)

(72) Inventor: YI-CHENG TSAI, Taichung City (TW)

(21) Appl. No.: 18/142,045

(22) Filed: May 2, 2023

(30) Foreign Application Priority Data
Jan. 19, 2023 (TW) 112102500

(51) Int. Cl. B23Q 3/06; B23Q 1/26; B23Q 1/28

(52) U.S. Cl. CPC B23Q 3/062; B23Q 1/262; B23Q 1/28

(57) ABSTRACT

A modular machine tool processing jig includes a base body having at least a positioning device and a movement adjusting device; at least a clamping positioning seat fixed on the base body through the positioning device and having at least a positioning clamping face, by which providing an efficient and accurate positioning effect; and at least a clamping adjusting seat disposed on the base body through the movement adjusting device, so as to adjust the interval between the clamping adjusting seat and the clamping positioning seat along an axial direction for different workpiece sizes. Therein, the clamping adjusting seat has at least a clamping assembly having at least a clamping face. The clamping assembly adjusts the interval between the clamping face and the positioning clamping face for clamping a to-be-processed workpiece.

### BACKGROUND OF THE INVENTION

### 1. Field of the Invention

The present invention relates to machine tool processing jigs, and more particularly, to a jig applicable to differently sized to-be-processed workpieces and having multiple modular combinations for various processing conditions.

### 2. Description of the Related Art

During the processing of general machine tools, in order to stably fix differently shaped workpieces on the machine tool, a specific processing jig is usually designed for a certain shape of to-be-processed workpiece. Such jig is able to firmly fix the workpiece on the machine tool to prevent the workpiece from accidentally falling off during the processing. Also, the workpieces are allowed to be arranged on multiple sets of processing jigs in advance, and the processing jigs are then placed on/retrieved from the machine tool manually or through a mechanical arm, thereby reducing the workpiece loading and unloading time.

However, since the processing jigs are usually designed for specific to-be-processed workpieces, the processing jigs of different workpieces are unable to be universally shared. Therefore, when the target product of the production line is changed, most of the processing jigs have to be redesigned and manufactured, and those unable to be recycled and reused have to be discarded, resulting in an increase in production cost and waste of resource.

Furthermore, when a general to-be-processed workpiece is placed on the processing jig, there is a lack of effective positioning means and devices. Even if the to-be-processed workpiece is able to be fixed on an approximate position on the machine tool through the processing jig, a zero-setting correction and a tool calibration are still needed, so as to achieve an effective and accurate processing operation, which is critical to the precision processing of workpieces.

### SUMMARY OF THE INVENTION

To improve the issues above, the present invention discloses a modular machine tool processing jig. With the clamping adjusting seat effectively adjusting the interval with respect to the clamping positioning seat, the present invention is applicable to differently sized to-be-processed workpieces. Also, the clamping assembly adjusts the interval between the clamping face and the positioning clamping face, so as to provide a stable clamping force for clamping a to-be-processed workpiece. Further, the positioning clamping face is able to be a reference face for subsequent process, thereby achieving a effective and accurate positioning effect.

For achieving the aforementioned objectives, a modular machine tool jig in accordance with an embodiment of the present invention is provided, comprising:
a base body comprising at least a positioning device and a movement adjusting device disposed thereon;
at least a clamping positioning seat fixed on the base body through the positioning device, the clamping positioning seat comprising at least a positioning clamping face disposed thereon; and
at least a clamping adjusting seat disposed on the base body through the movement adjusting device, the movement adjusting device adjusting an interval between the clamping adjusting seat and the clamping positioning seat along an axial direction; wherein the clamping adjusting seat comprises at least a clamping assembly disposed thereon, the clamping assembly comprises at least a clamping face, and the clamping assembly adjusts an interval between the clamping face and the positioning clamping face, so as to clamp a to-be-processed workpiece.

Preferably, the movement adjusting device comprises an adjusting groove disposed on the base body. The adjusting groove comprises an opening. The width of the opening is smaller than the width of the adjusting groove.

Preferably, the adjusting groove has a sectional face formed in at least one of reversed T shape, dovetail groove, and trapezoid shape.

Preferably, the base body further comprises a reinforcement plate covering a surface of the base body, and the opening is disposed on the reinforcement plate and arranged above the adjusting groove.

Preferably, the positioning device comprises a plurality of positioning bores preformed on the surface of the base body, and at least a positioning pin disposed on the bottom of the clamping positioning seat.

Preferably, the positioning device comprises at least a fastening block disposed in the adjusting groove, and the clamping positioning seat and the fastening block are fastened through a fastening screw member.

Preferably, the clamping adjusting seat comprises at least an adjusting slide block disposed in the adjusting groove and fastened with the clamping adjusting seat through an adjusting screw member, such that the clamping adjusting seat is allowed to axially slide or be fixed along the adjusting groove.

Preferably, the clamping face comprises a first clamping face and a second clamping face disposed on two lateral sides of the clamping assembly, respectively. The first clamping face comprises a plurality of grooves on the surface thereof. The clamping assembly is selectively switchable for the first clamping face or the second clamping face to face the positioning clamping face.

Preferably, the clamping assembly comprises a first clamping block having the first clamping face on one side and a first slope on another side; a second clamping block having the second clamping face on one side and a second slope on another side; an adjusting member disposed between the first clamping block and the second clamping block and having two adjusting slopes arranged corresponding to the first slope and the second slope; an elastic member disposed between the first clamping block and the second clamping block, and elastically forcing the first clamping block and the second clamping block to abut against each other in general; and a clamping screw member passing through the adjusting member and having one end fastened to the clamping adjusting seat.

Preferably, the clamping positioning seat further comprises a rough process positioning member movably fastened on the clamping positioning seat, with the positioning clamping face disposed on a lateral side of the rough process positioning member. Also, the rough process positioning member comprises at least a jaw member having at least one portion protruding on a surface of the positioning clamping face.

Preferably, the grooves of the first clamping face comprise at least a horizontal groove and a vertical groove.

Preferably, the clamping positioning seat further comprises a fine process positioning member movably fastened on the clamping positioning seat, with the positioning clamping face disposed on a lateral side of the fine process positioning member.

Preferably, the clamping adjusting seat further comprises a fine process clamping member movably installed on the second clamping face.

Preferably, the clamping positioning seat further comprises a shaped positioning member movably fastened on the clamping positioning seat, with the positioning clamping face disposed on a lateral side of the shaped positioning member. The shape of the positioning clamping face of the shaped positioning member is allowed to be formed according to an outer profile of the to-be-processed workpiece.

Preferably, the clamping adjusting seat further comprises a shaped clamping member movably installed on the second clamping face, and the shaped clamping member comprises a shaped clamping face. The shape of the shaped clamping face is allowed to be formed according to the outer profile of the to-be-processed workpiece.

Preferably, the base body comprises a zero-point positioning device. The zero-point positioning device is allowed to be at least a pin bore or at least a pin on the bottom of the base body.

### BRIEF DESCRIPTION OF THE DRAWINGS

FIG. 1 is a perspective view of the combination structure in accordance with an embodiment of the present invention.

FIG. 2 is a partially sectional view of the present invention.

FIG. 3 is a side view of the present invention.

FIG. 4 is a schematic view illustrating the operation of the present invention.

FIG. 5 is another schematic view illustrating the operation of the present invention.

FIG. 6 is a schematic view in accordance with another embodiment of the present invention.

FIG. 7 is a schematic view illustrating the operation in accordance with another embodiment of the present invention.

FIG. 8 is a schematic view in accordance with still another embodiment of the present invention.

FIG. 9 is a perspective view of the combination structure of FIG. 1 taken from another viewpoint.

### DETAILED DESCRIPTION OF THE INVENTION

The aforementioned and further advantages and features of the present invention will be understood by reference to the description of the preferred embodiment in conjunction with the accompanying drawings where the components are illustrated based on a proportion for explanation but not subject to the actual component proportion.

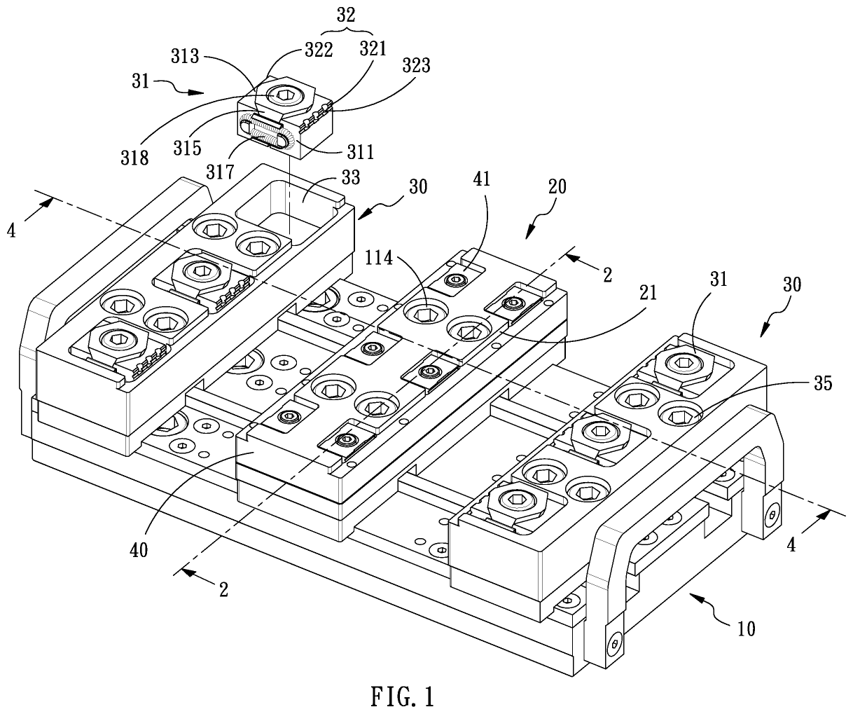

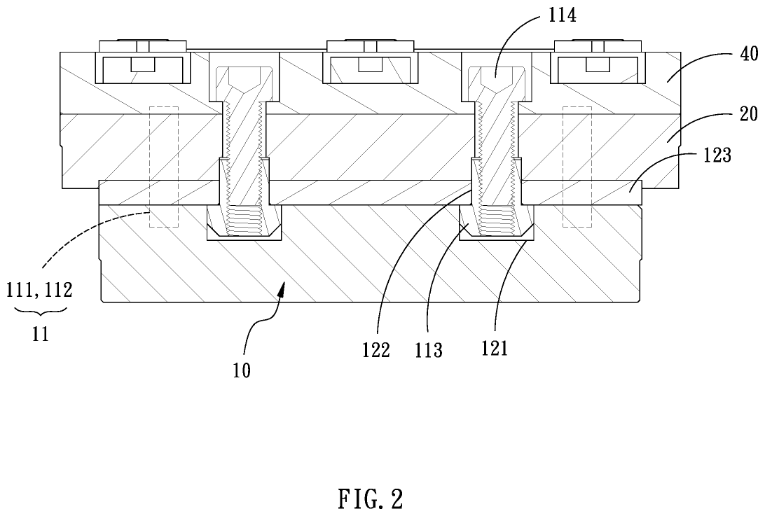

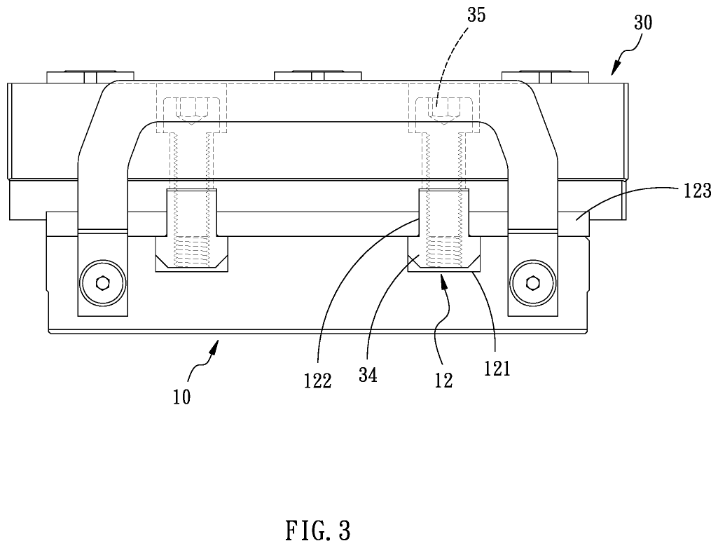

Referring to FIG. 1 to FIG. 5, the present invention provides a modular machine tool processing jig, comprising a base body 10, at least a clamping positioning seat 20, and at least a clamping adjusting seat 30.

The base body 10 comprises at least a positioning device 11 and a movement adjusting device 12. Therein, the movement adjusting device 12 comprises an adjusting groove 121 disposed on the base body 10. The adjusting groove 121 comprises an opening 122, and the width of the opening 122 is smaller than the width of the adjusting groove 121. For example, the shape of the sectional face of the adjusting groove 121 is allowed to be one of reversed T shape, dovetail groove, and trapezoid shape. In an embodiment, the base body 10 further comprises a reinforcement plate 123 covering the surface of the base body 10, and the opening 122 is disposed on the reinforcement plate 123 and arranged above the adjusting groove 121. Therefore, the base body 10 is allowed to be formed of lightweight material, such as aluminum or aluminum alloy, and the reinforcement plate 123 is formed of material with higher strength, such as steel, reinforced steel, or steel alloy. With such configuration, the base body 10 achieves the advantage of lightweight and provides a sufficient strength for meeting processing demand.

The at least one of the clamping positioning seat 20 is fixed on the base body 10 through the positioning device 11. In an embodiment, the positioning device 11 comprises a plurality of positioning bores 111 preformed on the surface of the base body 10, and at least a positioning pin 112 disposed on the bottom of the clamping positioning seat 20. Also, the positioning device 11 comprises at least a fastening block 113 disposed in the adjusting groove 121, and the clamping positioning seat 20 is fastened with the fastening block 113 through a fastening screw member 114 passing therethrough. Therein, the clamping positioning seat 20 comprises at least a positioning clamping face 21 thereon. With the positioning device 11, when the clamping positioning seat 20 is installed on the base body 10, the positioning clamping face 21 is able to be accurately positioned, so as to be applied as the reference face of subsequent processing.

The at least one of the clamping adjusting seat 30 is disposed on the base body 10 through the movement adjusting device 12 and arranged in parallel to the clamping positioning seat 20, such that the movement adjusting device 12 is used to adjust the interval between the clamping adjusting seat 30 and the clamping positioning seat 20 along an axial direction. In an embodiment, the clamping adjusting seat 30 comprises at least an adjusting slide block 34 disposed in the adjusting groove 121. The clamping adjusting seat 30 is fastened to the adjusting slide block 34 through an adjusting screw member 35, such that the clamping adjusting seat 30 is allowed to axially slide or be fixed along the adjusting groove 121. Therein, the clamping adjusting seat 30 comprises at least a clamping assembly 31 thereon. The clamping assembly 31 comprises at least a clamping face 32, and the clamping assembly 31 is able to adjust the interval between the clamping face 32 and the positioning clamping face 21, so as to clamp a to-be-processed workpiece 90.

Therein, the clamping face 32 comprises a first clamping face 321 and a second clamping face 322 disposed on two lateral sides of the clamping assembly 31, respectively. The first clamping face 321 comprises a plurality of grooves 323, and the grooves 323 on the first clamping face 321 comprises at least a horizontal groove and a vertical groove. Further, the clamping adjusting seat 30 concavely comprises a containing groove 333 for receiving the clamping assembly 31. One side of the containing groove 33 facing the clamping positioning seat 20 has at least one part being open, so that the clamping assembly 31 is selectively switchable for the first clamping face 321 or the second clamping face 322 to face the positioning clamping face 21.

In an embodiment, the clamping assembly 31 comprises a first clamping block 311, a second clamping block 313, an adjusting member 315, an elastic member 317, and a clamping screw member 318.

The first clamping block 311 comprises the first clamping face 321 on one side and a first slope 312 on another side.

The second clamping block 313 comprises the second clamping face 322 on one side and a second slope 314 on another side.

The adjusting member 315 is disposed between the first clamping block 311 and the second clamping block 313, and comprises two adjusting slopes 316 corresponding to the first slope 312 and the second slope 314, respectively.

The elastic member 317 is disposed between the first clamping block 311 and the second clamping block 313, and elastically forces the first clamping block 311 and the second clamping block 313 to abut against each other in general.

The clamping screw member 318 passes through the adjusting member 315 and has one end fastened to the clamping adjusting seat 30.

With the foregoing configuration, operation of the present invention will be illustrated below.

Referring to FIG. 1 to FIG. 3, in the embodiment, a rough processing of the to-be-processed workpiece 90 is taken as an example for illustration. Therein, the clamping positioning seat 20 further comprises a rough process positioning member 40, which is movably fastened on the clamping positioning seat 20, with the positioning clamping face 21 disposed on at least one side of the rough process positioning member 40. Also, the rough process positioning member 40 comprises at least a jaw member 41 having at least one portion protruding on the surface of the positioning clamping face 21.

In the present invention, the arrangement of the clamping positioning seat 20 and the clamping adjusting seat 30 is movably adjusted according to the size of the to-be-processed workpiece 90. For example, in the embodiment, one clamping positioning seat 20 and two clamping adjusting seats 30 are provided, and the clamping positioning seat 20 is disposed between the two clamping adjusting seats 30. In other embodiments, for a to-be-processed workpiece 90 having a larger size, one clamping positioning seat 20 and one clamping adjusting seat 30 are provided and disposed on the base body 10 in adjacent to two sides thereof, such that a larger containing space is formed between the clamping positioning seat 20 and the clamping adjusting seat 30.

Further, the user is allowed to loosen the adjusting screw member 35, so as to loosen the adjusting slide block 34 in the adjusting groove 121 to become slidable, whereby the user is able to efficiently adjust the interval between the clamping positioning seat 20 and the clamping adjusting seat 30 according to different sizes of to-be-processed workpieces 90. After the interval adjustment, the user only needs to rotate the adjusting screw member 35 again to force the adjusting block 34 and the adjusting groove 121 to abut against each other, such that the clamping adjusting seat 30 is allowed to be stably fixed to the base body 10.

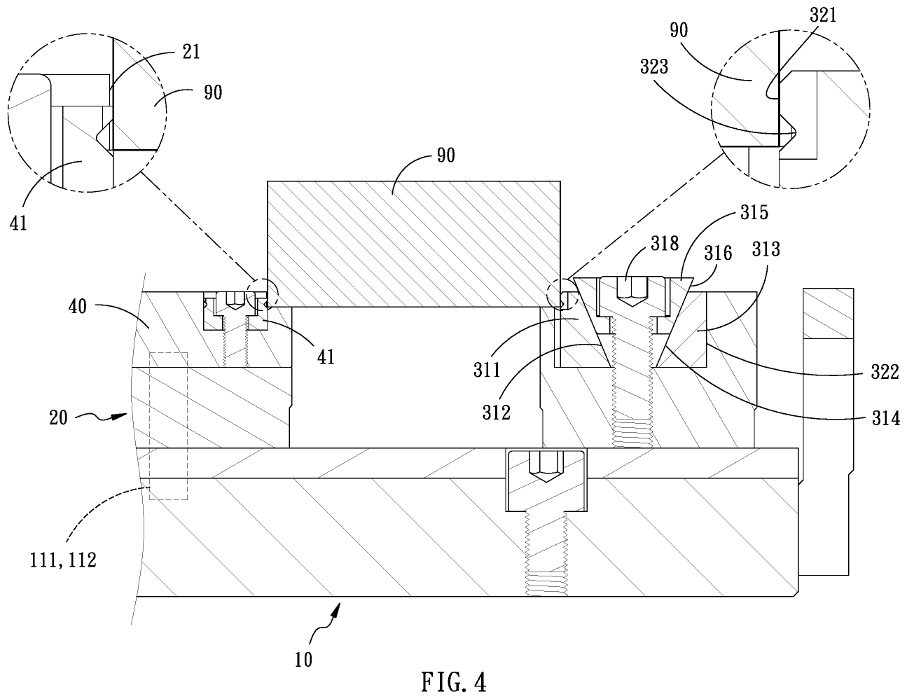

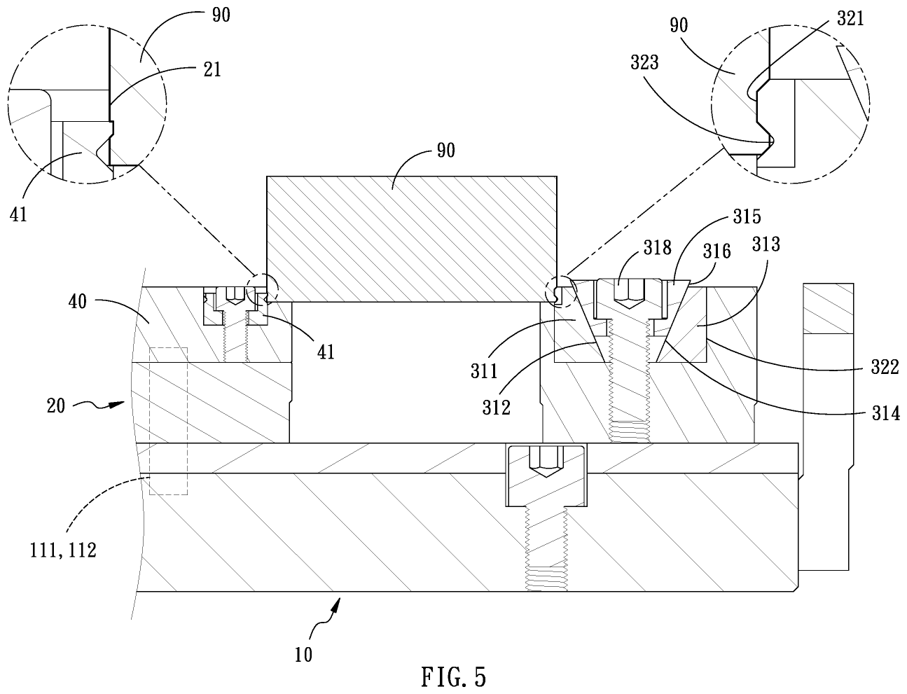

Referring to FIG. 4, the to-be-processed workpiece 90 is placed between the positioning face 21 and the first clamping face 321. When the user rotates the clamping screw member 318 of the clamping assembly 31 to be tightened, the adjusting member 315 is driven to abut against the first clamping block 311 and the second clamping block 313; meanwhile with the operation of the adjusting slope 316, the first slope 312, and the second slope 314, the first clamping block 311 and the second clamping block 313 move toward the lateral side. At the same time, the first clamping face 321 of the first clamping block 311 pushes the to-be-processed workpiece 90 toward the positioning clamping face 21, until the to-be-processed workpiece 90 is stably clamped and fixed by the positioning clamping face 21 and the first clamping face 321 (as shown by FIG. 5).

Therein, during the rough processing, due to a large feed amount and a strong cutting force, the clamping stability of the to-be-processed workpiece 90 has to be assured. With the jaw member 41 of the present invention, when the to-be-processed workpiece 90 is clamped to tightly abut against the positioning clamping face 21, the jaw member 41 protruding on the surface of the clamping face 21 is embedded and engaged on the surface of the to-be-processed workpiece 90, providing a strong clamping fixing force. Similarly, the groove 323 of the first clamping face 321 is also embedded and engaged on the surface of the to-be-processed workpiece 90. Also, due to the horizontal groove and the vertical groove, the grooves 323 are capable of resisting the processing force from different directions. As for the engagement marks left on the surface of the to-be-processed workpiece 90, those marks will be removed in the subsequent fine cutting or surface processing without causing any influence.

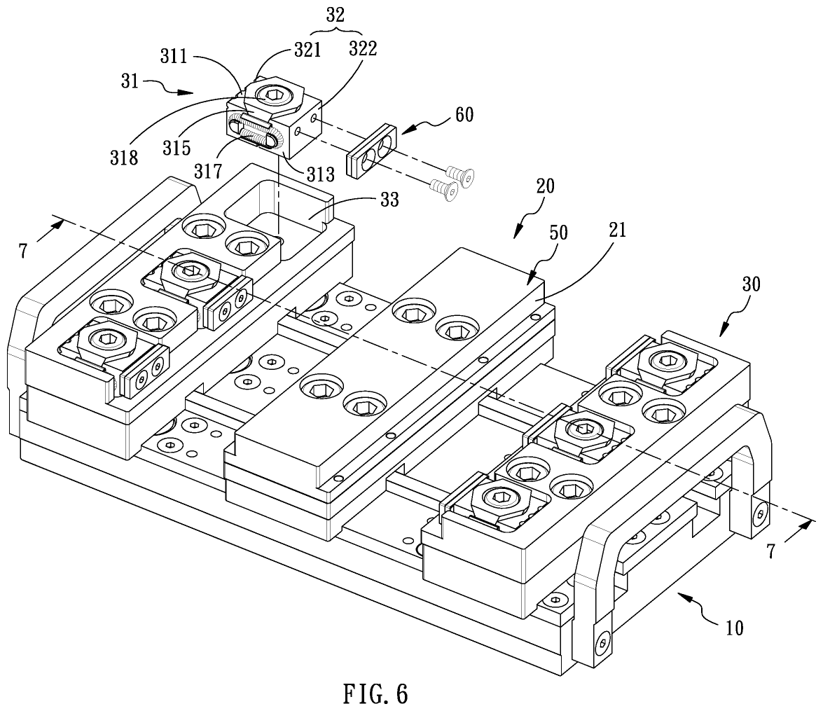

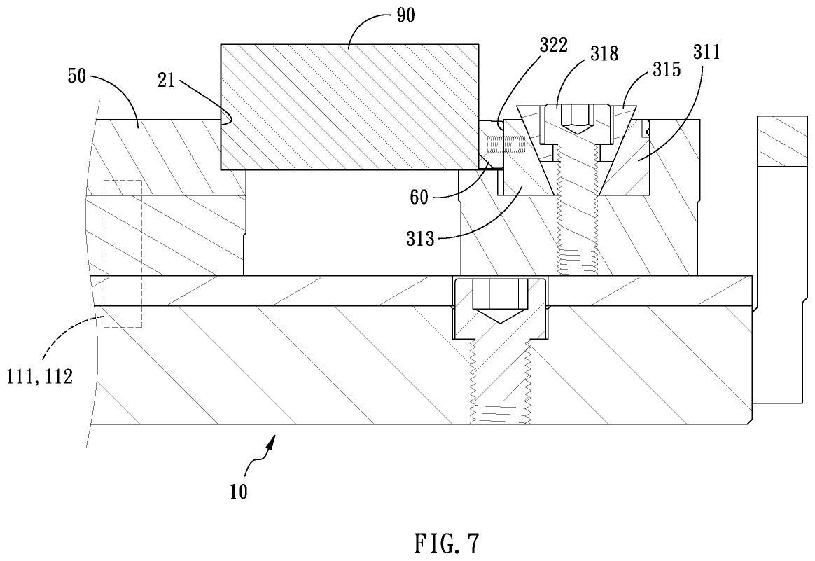

Referring to FIG. 6 and FIG. 7, in another embodiment, a fine processing of the to-be-processed workpiece 90 is taken as an example for illustration. Therein, the clamping positioning seat 20 further comprises a fine process positioning member 50, which is movably fastened on the clamping positioning seat 20, with the positioning clamping face 21 disposed on a side of the fine process positioning member 50. Meanwhile, the second clamping face 322 of the clamping assembly 31 is arranged to face the positioning clamping face 21. Due to a small feed amount and a weaker cutting force, and the need to avoid marks and flaws left on the surface during the clamping process, the second clamping face 322 and the positioning clamping face 21 are formed into a smooth surface, so as to prevent the occurrence of marks and flaws during the clamping and processing operation. Also, the clamping adjusting seat 30 further comprises a fine process clamping member 60, which is movably installed on the second clamping face 322. The fine process clamping member 60 is formed of soft materials, such as metal, rubber, or plastic material having a lower hardness, so as to further enhance the protection upon the to-be-processed workpiece 90, thereby effectively preventing the surface of the to-be-processed workpiece 90 from having marks thereon due to clamping.

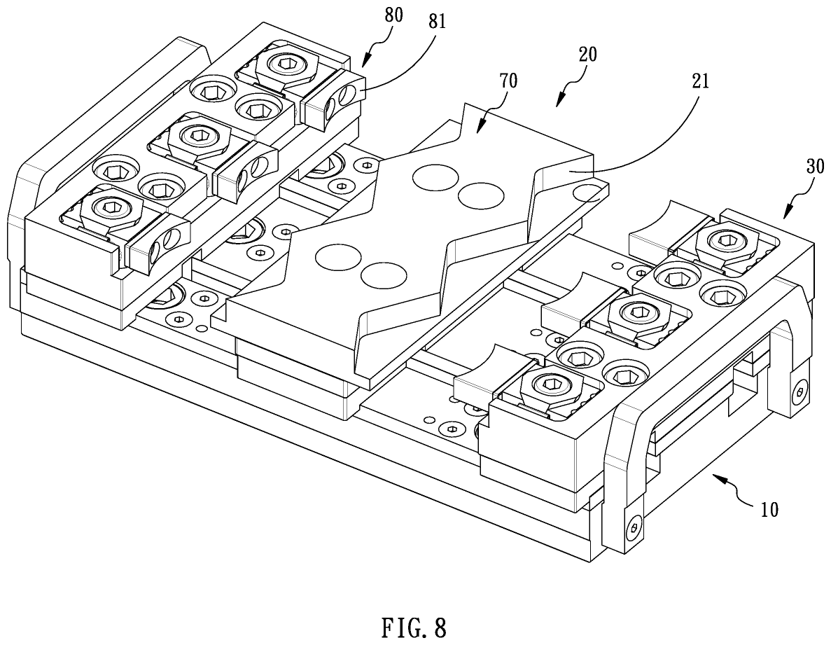

Referring to FIG. 8, in another embodiment, the clamping positioning seat 20 further comprises a shaped positioning member 70 movably fastened on the clamping positioning seat 20, with the positioning clamping face 21 disposed on a side of the shaped positioning member 70. The shape of the positioning clamping face 21 of the shaped positioning member 70 is allowed to be formed according to the outer profile of the to-be-processed workpiece 90. Therein, the clamping adjusting seat 30 further comprises a shaped clamping member 80 movably installed on the second clamping face 322, and the shaped clamping member 80 comprises a shaped clamping face 81. The shape of the shaped clamping face 81 is allowed to be formed according to the outer profile of the to-be-processed workpiece 90. When the outer profile of the to-be-processed workpiece 90 is a relatively complicated shape or a shape which is not easily fixed, the present invention achieves a better clamping effect. Also, except the shaped positioning member 70 and the shaped clamping member 80, most of the components are able to be recycled or shared for different workpieces, thereby greatly reducing the production cost and waste of resources.

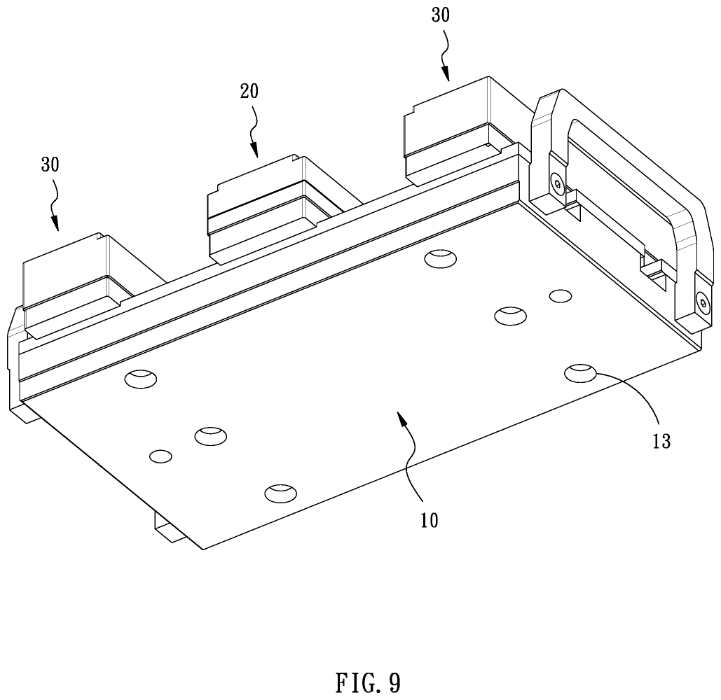

In addition, referring to FIG. 9, the base body 10 comprises a zero-point positioning device 13, which is allowed to be at least a pin bore or at least a pin disposed on the bottom of the base body 10, while relative fastening devices are allowed to be disposed at the corresponding positions of the machine. Therefore, whether the present invention is disposed on the machine manually or through a mechanical arm, the zero-point positioning device 13 is applied to efficiently and accurately installed the present invention and the to-be-processed workpiece 90 on the predetermined position, greatly reducing the time demand for subsequent zero-setting correction and tool calibration.

With such configuration, the present invention achieves following advantages.

With the base body 10, the clamping positioning seat 20, and the clamping adjusting seat 30, the present invention is able to effectively adjust the appropriate interval for clamping differently sized to-be-processed workpieces 90, so that the present invention is applicable to various to-be-processed workpieces 90, thereby improving the issue of specific processing jigs unable to be shared, the production cost rising, and the waste of resources.

With the clamping positioning seat 20 and the positioning device 11, the present invention easily and accurately positions the positioning clamping face 21. When the to-be-processed workpiece 90 is clamped and fixed, its lateral side tightly abuts against the positioning clamping face 21, providing a reference face for subsequent processing, thereby greatly reducing the time needed for subsequent operations, such as zero-setting correction and tool calibration.

The clamping positioning seat 20 and the clamping adjusting seat 30 are allowed to incorporate different modular components, such that the present invention fulfills different demands of rough processing, fine processing, and shaped processing operations.

Most of the components in the present invention are able to be recycled or shared for different workpieces, except the shaped positioning member 70 and the shaped clamping member 80, so that the production cost and waste of resources are greatly reduced.

Although particular embodiments of the invention have been described in detail for purposes of illustration, various modifications and enhancements may be made without departing from the scope of the invention. Accordingly, the invention is not to be limited except as by the appended claims.

What is claimed is:

1. A modular machine tool processing jig, comprising:
a base body comprising at least a positioning device and a movement adjusting device;
at least a clamping positioning seat fixed on the base body through the positioning device, the clamping positioning seat comprising at least a positioning clamping face; and
at least a clamping adjusting seat disposed on the base body through the movement adjusting device, the movement adjusting device adjusting an interval between the clamping adjusting seat and the clamping positioning seat along an axial direction, wherein the clamping adjusting seat comprises at least a clamping assembly disposed thereon, the clamping assembly comprises at least a clamping face, and the clamping assembly adjusts an interval between the clamping face and the positioning clamping face to clamp a to-be-processed workpiece.

2. The modular machine tool processing jig of claim 1, wherein the movement adjusting device comprises an adjusting groove disposed on the base body; the adjusting groove comprises an opening; a width of the opening is smaller than a width of the adjusting groove.

3. The modular machine tool processing jig of claim 2, wherein the adjusting groove has a sectional face which is formed in at least one of reversed T shape, dovetail groove, and trapezoid shape.

4. The modular machine tool processing jig of claim 2, wherein the base body further comprises a reinforcement plate covering a surface of the base body, and the opening is disposed on the reinforcement plate and arranged above the adjusting groove.

5. The modular machine tool processing jig of claim 1, wherein the positioning device comprises a plurality of positioning bores preformed on a surface of the base body, and at least a positioning pin disposed on a bottom of the clamping positioning seat.

6. The modular machine tool processing jig of claim 2, wherein the positioning device comprises at least a fastening block disposed in the adjusting groove, and the clamping positioning seat and the fastening block are fastened through a fastening screw member.

7. The modular machine tool processing jig of claim 2, wherein the clamping adjusting seat comprises at least an adjusting slide block disposed in the adjusting groove; the clamping adjusting seat and the adjusting slide block are fastened through an adjusting screw member, such that the clamping adjusting seat axially slides or is fixed along the adjusting groove.

8. The modular machine tool processing jig of claim 1, wherein the clamping face comprises a first clamping face and a second clamping face disposed on two lateral sides of the clamping assembly, respectively; the first clamping face comprises a plurality of grooves disposed on a surface thereof; the clamping assembly is selectively switchable for the first clamping face or the second clamping face to face the positioning clamping face.

9. The modular machine tool processing jig of claim 8, wherein the clamping assembly comprises:
a first clamping block comprising the first clamping face on one side thereof and a first slope on another side thereof;
a second clamping block comprising the second clamping face on one side thereof and a second slope face on another side thereof;
an adjusting member disposed between the first clamping block and the second clamping block, and comprising two adjusting slopes disposed corresponding to the first slope and the second slope;
an elastic member disposed between the first clamping block and the second clamping block, the elastic member elastically forcing the first clamping block and the second clamping block to abut against each other in general; and
a clamping screw member passing through the adjusting member and comprising one end fastened to the clamping adjusting seat.

10. The modular machine tool processing jig of claim 8, wherein the clamping positioning seat further comprises a rough process positioning member movably fastened on the clamping positioning seat, with the positioning clamping face disposed on a lateral side of the rough process positioning member; the rough process positioning member comprises at least a jaw member having at least a portion protruding on a surface of the positioning clamping face.

11. The modular machine tool processing jig of claim 10, wherein the grooves on the surface of the first clamping face comprise at least a horizontal groove and a vertical groove.

12. The modular machine tool processing jig of claim 8, wherein the clamping positioning seat further comprises a fine process positioning member movably fastened on the clamping positioning seat, with the positioning clamping face disposed on a lateral side of the fine process positioning member.

13. The modular machine tool processing jig of claim 12, wherein the clamping adjusting seat further comprises a fine process clamping member movably installed on the second clamping face.

14. The modular machine tool processing jig of claim 8, wherein the clamping positioning seat further comprises a shaped positioning member movably fastened on the clamping positioning seat, with the positioning clamping face disposed on a lateral side of the shaped positioning member; the positioning clamping face of the shaped positioning member is shaped according to an outer profile of the to-be-processed workpiece.

15. The modular machine tool processing jig of claim 14, wherein the clamping adjusting seat comprises a shaped clamping member movably installed on the second clamping face; the shaped clamping member comprises a shaped clamping face; the shaped clamping face is shaped according to the outer profile of the to-be-processed workpiece.

16. The modular machine tool processing jig of claim 1, wherein the base body comprises a zero-point positioning device; the zero-point positioning device is at least a pin bore or at least a pin disposed on a bottom of the base body.
